(19) United States
(12) Patent Application Publication
(10) Pub. No.: US 2026/0211129 A1
(43) Pub. Date: Jul. 23, 2026

(54) INTELLIGENT GAMMA PROBE

(71) Applicant: "TUVI AND KO" EOOD, Sofia (BG)

(72) Inventor: Boris KARAKUSHEV, Sofia (BG)

(73) Assignee: "TUVI AND KO" EOOD, Sofia (BG)

(21) Appl. No.: 19/147,151

(22) PCT Filed: Apr. 5, 2023
(86) PCT No.: PCT/BG2023/050002

§ 371 Date: Jul. 10, 2025

(30) Foreign Application Priority Data
Jan. 10, 2023 (BG) BG/U/2023/5651

(51) Int. Cl. G01T 1/175; G01T 1/15; G01T 1/18

(52) U.S. Cl. CPC G01T 1/175; G01T 1/15; G01T 1/18

(57) ABSTRACT

The present invention relates to an intelligent gamma probe that will find application for dosimetry and radiation monitoring of background gamma radiation in the environment, nuclear energy, mining, oil and gas industries. The developed intelligent gamma probe includes a housing (1) in which first and second ionizing radiation detectors (2) and (3) are located, one directionally connected to a high voltage source (4) and to a shaper (5). The high voltage source (4) and the shaper (5) are one directionally connected to a microcomputer (6). A microcomputer (6) is bidirectionally connected to a LAN card (7), bidirectionally connected to a PoE power supply (8), which is bidirectionally connected to a connector (9). The PoE power supply (8) via a network cable is one directionally connected to the high voltage source (4), to the shaper (5), to the microcomputer (6), to the LAN card (7) and to the connector (9).

### TECHNICAL FIELD

The present invention relates to Intelligent Gamma Probe (IGP) which will be applicable for dosimetry and radiation control of environmental background gamma radiation monitoring, nuclear energy, mining, oil, and gas industries.

### BACKGROUND OF THE INVENTION

The radiation monitoring systems known in practice are classified into several categories-for monitoring radiation in the environment, for personal dose measurement, for surface monitoring, for radioactive materials and others. The measurement technology applied in industrial environment is primarily based on the ability of radiation to penetrate materials.

The known intelligent gamma probes consist of one or more gamma radiation detectors and an electronic module that controls the detectors and processes the signal received from them. The received signal is transmitted to a workstation with installed software for data visualization, storage, and processing. The manufacturers of intelligent gamma probes usually use RS232, RS485 interface or USB, and the communication protocol is specific and different for each manufacturer. This limits the use of the probes with software from the same manufacturer. In addition, the user is limited in situation if it needs to upgrade the systems, maintain the software, etc.

### SUMMARY OF THE INVENTION

The objective of the invention is to create an intelligent gamma probe that provides data transmission over Ethernet using a standard industrial communication protocol and can be integrated with any industrial software, both in newly built systems and in existing ones.

The objective is achieved by creating an intelligent gamma probe, which includes a housing in which the first and the second ionizing radiation detectors are located, one directionally connected to a high voltage source and to a shaper. The high voltage source and the shaper are one directionally connected to a microcomputer. The microcomputer is bidirectionally connected to a LAN card, bidirectionally connected to a PoE power supply, which is bidirectionally connected to a connector. The PoE power supply via a network cable is one directionally connected to the high voltage source, to the shaper, to the microcomputer, to the LAN card and to the connector.

The advantage of the developed intelligent gamma probe is the provided possibility both for accurate measurements and for safe and reliable data exchange in the network by transmitting the signal according to a standard “open” industrial protocol, which is software independent-OPC UA (Open Platform Communications Unified Architecture).

### BRIEF DESCRIPTION OF THE DRAWING

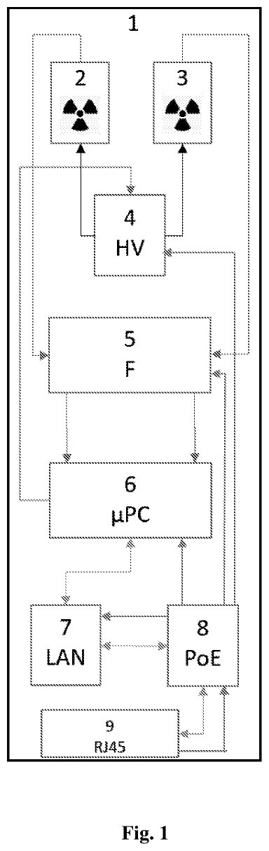

The current invention is illustrated in the attached FIG. 1, which is a schematic diagram of the intelligent gamma probe, according to the invention.

### DESCRIPTION OF EMBODIMENT OF THE INVENTION

The invention is an intelligent gamma probe with two Geiger-Muller detectors and a mini-computer that controls the detectors, processes the pulses from them, performs the necessary calculations and transmits the data via Ethernet using an “open” industry standard communication protocol that is software independent.

The developed intelligent gamma probe, shown in FIG. 1, includes a housing 1, in which are located first and second ionizing radiation detectors 2 and 3, one directionally connected to a high voltage source 4 and to a shaper 5. The high voltage source 4 and the shaper 5 are one directionally connected to a microcomputer 6. The microcomputer 6 is bidirectionally connected to a LAN card 7, bidirectionally connected to a PoE power supply 8, which is bidirectionally connected to a connector 9. The PoE power supply 8 via a network cable is one directionally connected to the high voltage source 4, to the shaper 5, with the microcomputer 6, with the LAN card 7 and with the connector 9.

Housing 1 of the probe is cylindrical in shape, made of metal, and is closed on both sides with caps sealed with O-rings.

The first ionizing radiation detector 2 operates at dose rates from 0.050 μSv/h to about 1 Sv/h, which is the middle of the dose rate range. During its operation, detector 2 generates triangular pulses depending on the dose rate of ionizing radiation. The second ionizing radiation detector 3 operates at dose rates from about the middle of the dose rate range, i.e. from about 1 Sv/h to 2 Sv/h. Similarly to detector 2, during its operation detector 3 generates triangular pulses depending on the dose rate of ionizing radiation-the higher the dose rate, the more pulses are generated. Ionizing radiation detectors 2 and 3 are supplied with high voltage from the high voltage source 4 and transmit the generated pulses to the shaper 5. Detectors 2 and 3 provide the probe with a dose rate range of 0.050 μSv/h to 2 Sv/h at an energy range from 60 keV to 3 MeV. Combinations with other pairs of detectors are also possible to give higher measurement efficiency, but with a smaller range of dose rate.

The high voltage source 4 is a high voltage transformer with control of the two channels for supplying the high voltage to the detectors 2 and 3. The high voltage can be supplied to each detector separately, as well as simultaneously to both. The high voltage source 4 is controlled by the microcomputer 6 and is powered by a network cable from the PoE power supply 8. Power over Ethernet (POE) is a technology that allows network cables to carry electrical energy. The PoE power supply 8 supplies the probe with the necessary voltage and separates the power supply from the communication, which takes place over the network connecting (FTP) cable. The PoE power supply 8 communicates bidirectionally with the LAN card 7 and supplies power to all modules in the probe.

The shaper 5 receives the triangular pulses from the ionizing radiation detectors 2 and 3 and converts them into rectangular pulses of precisely defined length and polarity. The shaper 5 receives the pulses from detectors 2 and 3 separately and transmits them to the microcomputer 6 also separately.

The microcomputer 6 controls the channels of the high voltage that is supplied to the ionizing radiation detectors 2 and 3 according to preset parameters; receives and counts the pulses sent by the shaper 5 for each detector separately; calculates dose rate values; stores the serial number; in addition, there is a built-in OPC server that transmits the data to the other standard devices by communicating bidirectionally through the LAN card 7. In addition, the microcomputer 6 has a configured Web server for setting the IP address, diagnostics and checks with access control. The data that is transmitted via the industry standard “open” OPC UA protocol includes IP address, MAC address, probe temperature, serial number, dose rate, number of pulses for each detector, indication of operation of each detector, dose rate threshold value for switching between the detectors. The OPC protocol is an interoperability standard for secure and reliable data exchange in the industrial automation space and other industries. It is platform independent and ensures a seamless flow of information between devices from multiple vendors.

The LAN card 7 provides the communication between the probe and peripheral devices connected via Ethernet.

Connector 9 is an RJ45 connector that provides hardware connectivity to the FTP cable and probe sealing. It also provides the connection and power supply to the PoE power module 8.

The developed probe is of the ‘Plug and Play’ type, i.e. after plugging into Ethernet, it starts working and transmitting the data, and can be integrated into any existing system or can be integrated when building new systems, regardless of the manufacturer of the hardware and/or software. The probe transmits the signal via OPC UA (Open Platform Communications Unified Architecture), which is an industrial protocol and is software independent. The interface through which the probe connects to peripheral devices is TCP/IP, which allows it to be powered by a network cable using PoE technology and has a single RJ45 connector.

In this way, the probe can be integrated with any industrial software, both in newly built systems and in existing ones, which could relieve users, both in terms of time and costs. For local visualization and power in multi-channel systems, an industrial controller of the end users'choice can be used.

The intelligent gamma probe can be used in public information plates for background radiation and meteorological data. For this purpose, a standard industrial controller is used, which supplies the probe via PoE and reads the radiation background data via OPC UA. The controller configuration can include sensors for meteorological data—humidity, wind direction and speed, temperature and others. The controller displays the data on an industrial display.

The developed probe can also be used in systems for gamma radiation monitoring. Again, a standard industrial controller is used which powers the probe via PoE and reads background radiation data via OPC UA. The controller displays measurement values and alarm levels locally. Local stack light and sound alarms can be included and controlled with the controller configuration.

1. An intelligent gamma probe, characterized in that it includes a housing (1) in which first and second ionizing radiation detectors (2) and (3) are located, one directionally connected to a high voltage source (4) and to a shaper (5 ), the high voltage source (4) and the shaper (5) being one directionally connected to a microcomputer (6), which is bidirectionally connected to a LAN card (7), bidirectionally connected to a PoE power supply (8), which is bidirectionally connected to a connector (9), with the PoE power supply (8) via a network cable one directionally connected to the high voltage source (4), to the shaper (5), to the microcomputer (6), to the LAN card (7) and to the connector (9).
